(19) United States
(12) Patent Application Publication
(10) Pub. No.: US 2016/0097351 A1
(43) Pub. Date: Apr. 7, 2016

(54) SWIRL TYPE LP - EGR THROTTLE MECHANISM

(71) Applicant: BorgWarner Inc., Auburn Hills, MI (US)

(72) Inventors: Timm Kiener, Ludwigsburg (DE); Thomas Kritzinger, Frankenberg A.H. (AT); Urs Hanig, Stuttgart (DE); Michael Becker, Esslingen (DE)

(21) Appl. No.: 14/508,151

(22) Filed: Oct. 7, 2014

(51) Int. Cl. F02M 25/07

(52) U.S. Cl. CPC F02M 25/0722; F02M 25/0706; F02M 25/0717; F02M 25/0794

(57) ABSTRACT

A mechanism may include a housing with an inlet passage and an outlet passage joined to the inlet passage by a valve chamber. The valve chamber may contain a plurality of vanes. The vanes may be arranged to: substantially close flow between the inlet passage and the outlet passage; induce swirl between the inlet passage and the outlet passage in both a first direction and a second direction; and be positioned parallel to flow between the inlet passage and the outlet passage. Closing off flow from the inlet passage may enhance flow from an exhaust gas port to the outlet passage.

### TECHNICAL FIELD

The field to which the disclosure generally relates includes turbocharged internal combustion engines and more particularly, to flow control mechanisms.

### BACKGROUND

In vehicles with turbocharged internal combustion engines, exhaust gases may be used to drive a turbine that is connected to, and drives a compressor. The compressor may be driven to compress combustion air into the engine's intake manifold. Internal combustion engines may also include an exhaust gas recirculation valve to admit exhaust gases into the intake manifold.

### SUMMARY OF ILLUSTRATIVE VARIATIONS

A number of variations may include product including a housing with an exhaust gas port, an inlet passage, and an outlet passage joined to the inlet passage by a valve chamber containing a plurality of vanes. The vanes may be arranged to: substantially close flow through the valve chamber; and induce swirl between the inlet passage and the outlet passage in both a first direction and a second direction. When the vanes substantially close flow through the valve chamber, flow from the exhaust gas port to the outlet port may be induced.

A number of other variations may include a mechanism for influencing flow that may have an inlet port, an outlet port, and a flow passage between the inlet port and the outlet port. A valve chamber may be positioned in the flow passage. An exhaust gas port may be configured to admit a flow of exhaust gas and may open into the flow passage between the valve chamber and the outlet port. The mechanism may include a set of vanes that may be arranged to: induce swirl between the inlet port and the outlet port in both a first direction and a second direction; and close off flow from the inlet port thereby inducing flow from the exhaust gas port to the outlet port.

A number of other variations may include a mechanism for effecting swirl and for throttling flow. The mechanism may include an inlet port, an outlet port, and a flow passage between the inlet port and the outlet port. A valve chamber may be in the flow passage. An exhaust gas port may be configured to admit a flow of exhaust gas into the flow passage and may open to the flow passage between the valve chamber and the outlet port. A set of vanes may be positioned in the valve chamber. Each vane in the set of vanes may include a leading edge, a trailing edge, and a maximum thickness that is located closer to the leading edge than to the trailing edge. The set of vanes may be configured to rotate to effect swirl and throttle flow. The set of vanes may also be configured to rotate effectively closing off flow from the inlet port to enhance flow from the exhaust gas port to the outlet port.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is an isometric view of a swirl type low pressure-exhaust gas recirculation throttle mechanism according to a number of variations.

FIG. 2 is a cross sectional view of a swirl type low pressure-exhaust gas recirculation throttle mechanism according to a number of variations.

FIG. 3 is a cross sectional view taken through the vanes of a swirl type low pressure-exhaust gas recirculation throttle mechanism with individual bearings according to a number of variations.

FIG. 4 is a cross sectional view taken through the vanes of a swirl type low pressure-exhaust gas recirculation throttle mechanism with a bearing ring according to a number of variations.

FIG. 5 is an isometric view of a set of vanes and actuation mechanism according to a number of variations.

FIG. 6 is an end view of a set of vanes and actuation mechanism according to a number of variations.

FIG. 7 is longitudinal cross sectional view of a swirl type low pressure-exhaust gas recirculation throttle mechanism with LP-EGR inlet according to a number of variations.

FIG. 8 is longitudinal cross sectional view of a swirl type low pressure-exhaust gas recirculation throttle mechanism with LP-EGR inlet according to a number of variations.

FIG. 9 is a plan view of a vane for a swirl type low pressure-exhaust gas recirculation throttle mechanism according to a number of variations.

FIG. 10 is a cross sectional view of a vane for a swirl type low pressure-exhaust gas recirculation throttle mechanism according to a number of variations taken as indicated by the line a-a in FIG. 9.

FIG. 11 is longitudinal cross sectional view of a swirl type low pressure-exhaust gas recirculation throttle mechanism with LP-EGR inlet according to a number of variations.

FIG. 12 is longitudinal cross sectional view of a swirl type low pressure-exhaust gas recirculation throttle mechanism with LP-EGR inlet according to a number of variations.

FIG. 13 is longitudinal cross sectional view of a swirl type low pressure-exhaust gas recirculation throttle mechanism with LP-EGR inlet according to a number of variations.

### DETAILED DESCRIPTION OF ILLUSTRATIVE VARIATIONS

The following description of the variations is merely illustrative in nature and is in no way intended to limit the scope of the invention, its application, or uses.

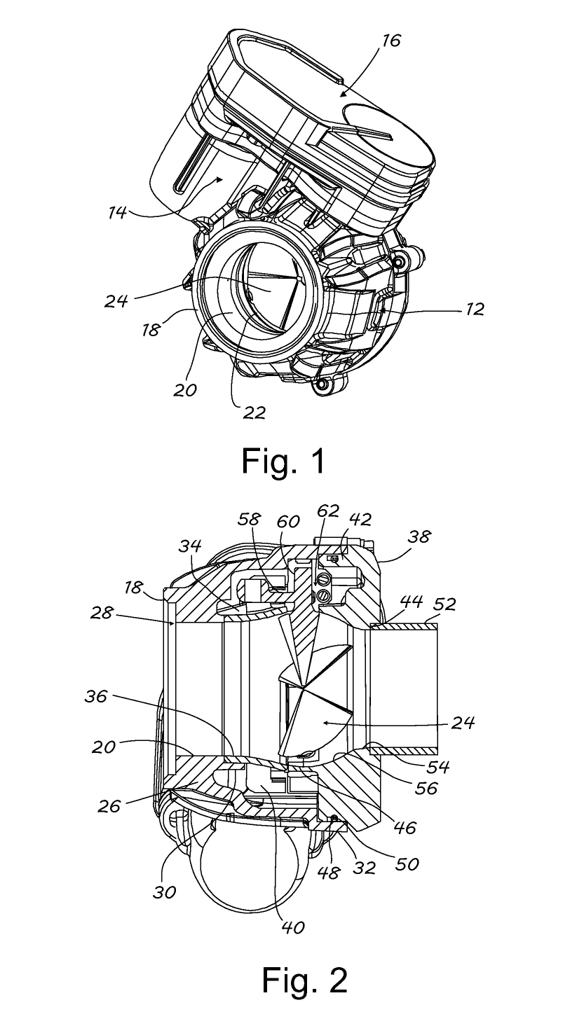

Referring to FIG. 1 a swirl type low pressure-exhaust gas recirculation (LP-EGR), throttle mechanism for influencing flow, such as near the inlet to a turbocharger compressor, may include a valve housing 12, an actuator housing 14, and an actuator cover 16. The valve housing 12 may include an inlet port 18 opening to an inlet passage 20 that leads to a valve chamber 22. Valve chamber 22 may include an element or elements that may be operable to selectively influence and/or close flow through the valve housing 12. The elements may be in the form of a number or set of vanes 24 that may be rotated by the actuator contained in actuator housing 14.

As can be seen in FIG. 2, valve housing 12 may include an inlet housing section 26 that may be generally cylindrical in shape and may include an inlet flange 28, an actuator flange 30, and a seal flange 32. Inlet housing section 26 may define the inlet port 18 and at least a portion of the inlet passage 20. The inlet flange 28 may be adapted to connect to a gas duct (not shown), to provide a supply of gas—which may be ambient air—to the swirl type LP-EGR throttle mechanism. The actuator flange 30 may be adapted to rotatably support an actuation ring 34 that may be of a flared or arcing cylindrical shape with a generally cylindrical section 36 that fits within actuator flange 30, and may rotate therein. Seal flange 32 may be adapted to mate with an outlet housing section 38, which with inlet housing section 26 may define a chamber 40 for the actuation mechanism of the swirl type LP-EGR throttle mechanism.

Outlet housing section 38 may include a seal flange 42, an outlet flange 44 and an actuator flange 46. Seal flange 42 may be a generally cylindrical shaped section with an outwardly facing annular groove 48. The groove 48 may carry an annular seal 50 that engages the seal flange 32 of inlet housing section 26 to provide a seal for the chamber 40. Outlet flange 44 may be generally cylindrical in shape and may be adapted to receive a gas duct 52 to convey gas flow out of the swirl type LP-EGR throttle mechanism. Gas duct 52 may include an exhaust gas inlet port (not shown). Actuator flange 46 may be adapted to engage actuation ring 34 so that the inlet housing section 26 and actuation ring 34 define inlet passage 20. Outlet housing section 38 including actuator flange 46 defines an outlet passage 54. In addition, actuation ring 34 and outlet housing section 38, including actuator flange 46, define a chamber 56 that is shaped to closely fit with a set of vanes 24 (shown in an open position), to minimize gaps. The assembly may be carried in only two housing sections. Optionally the assembly may be attached directly to a compressor housing or integrated with a compressor housing.

When the vanes 24 are closed (as shown in FIG. 1), they collectively result in a substantial closure between the inlet passage and outlet passage with minimal gaps. Vanes 24 may include an individual arm 58 that may be deflected by rotation of actuation ring 34 to rotate the vanes 24 between a variety of open and closed positions. The vanes may include a shaft 60 that is supported in a bearing 62 to facilitate rotation.

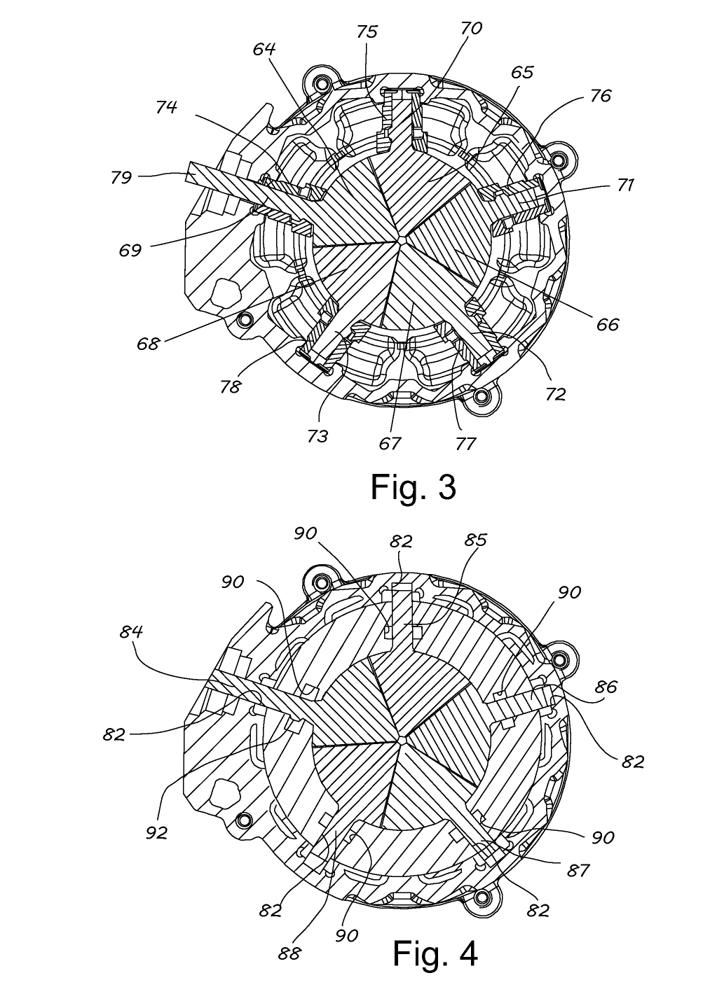

FIG. 3 shows a swirl type LP-EGR throttle mechanism with vanes 64-68 shown in a closed position. The vanes include shafts 69-73, which are supported in bearings 74-78. Vane 64 may be the primary vane and includes a shaft 69 that extends through and exits bearing 74 and includes a free end 79 to be driven by a rotary actuator. Only the vane 64 may be driven by the rotary actuator in this variation.

FIG. 4 shows a variation with a single bearing ring 80 that supports five vanes. Bearing ring 80 may be generally annular in shape and contained within the valve housing 94. Bearing ring 80 includes five openings 82 that rotatably receive vane shafts 84-88. Intersecting with openings 82 are slots 90 within which the lever arms extending from shafts 84-86 may translate.

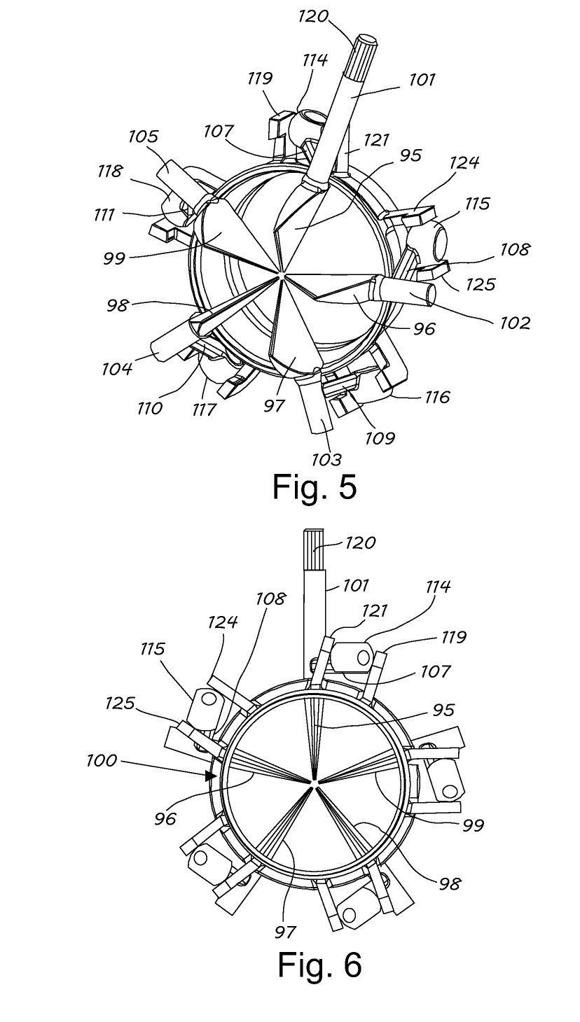

FIGS. 5 and 6 show the interaction between a set of vanes 95-99 and an actuation ring 100 according to a number of variations. In FIG. 5, the vanes are viewed from their trailing edges and in FIG. 6 the vanes are viewed from their leading edges. The number of vanes included may vary according to the application. Each vane includes a vane element and an extending shaft 101-105. Vane 95 may be the primary vane as illustrated and as such is driven by an actuator which engages and selectively rotates shaft 101 at driven end 106. Each shaft includes a lever arm 107-111 that terminates in a semi-spherical ball type bearing or joint 114-118. The joint 114 is engaged between arms 120 and 121 that extend radially from actuation ring 100. As the driven end 120 of shaft 101 is rotated by an actuator, lever arm 107 and joint 114 rotate with the shaft 101 applying force to either arm 120 or arm 121 (depending on the rotational direction), thereby rotating the actuator ring 100. Rotation of the actuator ring 100 causes (in the case of vane 96), the arms 124 and 125 to apply force to joint 115 and through shaft 108 to rotate shaft 102 in unison with the rotation of shaft 101. This causes the vane elements of vanes 95 and 96 to rotate together in the same rotational direction and the same amount. Similarly, through rotation of the actuation ring 100 all vanes 95-99 are actuated in unison and rotational motion of the primary vane is transferred through the actuation ring to the other vanes. The actuation ring 100 acts as a synchronizing element for the vane positions.

Through this mechanism, the vanes may be driven through a variety of positions one of which may be to close the flow path through the swirl type LP-EGR throttle mechanism. At this closed position the vane elements are perpendicular to the flow path at 90 degrees. Closing the flow path maximizes the draw of low pressure EGR gas downstream from the swirl type LP-EGR throttle mechanism. Another position may be to position the vanes such as to open the flow path through the swirl type LP-EGR throttle mechanism so that the vane elements are parallel to the flow path at 0 degrees. In addition, the driven end 120 may be rotated in one direction to move the vanes 95-99 to open the flow path providing a number of positions between 0 and 90 degrees of rotation that induces swirl in a first direction that may be in the same direction of rotation as a compressor wheel that may be downstream in the flow path. The driven end 120 may be rotated in a second direction to move the vanes 95-99 to open the flow path providing a number of positions between 0 and −90 degrees of rotation that induces swirl in a second direction that may be in the opposite direction of rotation as a compressor wheel that may be downstream in the flow path.

The vane design may be a one piece solution were the vane 95-99, shaft 101-105, lever arm 107-111, and joint 114-118, which may be achieved through injection molding or joined during assembly. In particular joining by 2k injection molding for plastics may be used by molding the vanes 95-99/shafts 101-105 into the joint 114-118 or bearing ring 80. To optimize mechanical and chemical properties different types of plastics may be paired. A material with higher grade and wear resistance may be used where needed and lower cost materials may be used for the balance of the component parts. Through 2k injection molding and use of a bearing ring or individual bearings, the vane shafts may be molded into the bearing openings. This may simplify the assembly process. Shrinkage of the shafts may be set to create the desired clearance between a shaft and its bore. Furthermore, wear and friction behavior may be optimized by using different materials. While molding the shaft into its bore, the vane elements and the levers or levers with joints may be molded to the shaft at the same time.

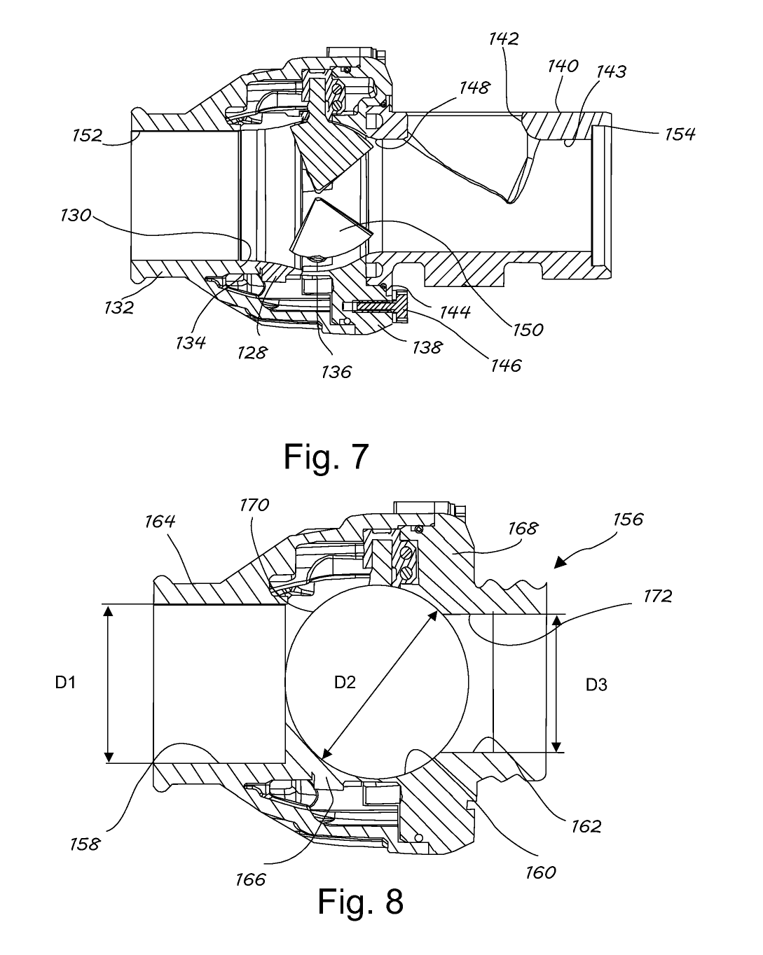

Referring to FIG. 7, the actuation ring 128 may be positioned in the axial (flow), direction at one end by the annular seat 130 formed in inlet housing section 132 adjacent actuator flange 134 and at the other end by actuator flange 136 of outlet housing section 138. The actuation ring 128 may be positioned in the radial direction (perpendicular to flow), by the actuator flange 134. Also shown is a gas duct 140 with EGR gas port 142 for receiving exhaust gas from an associated internal combustion engine. The gas duct 140 includes a flange 144 that may be seated against the outlet housing section 138 and clamped thereto by a number of bolts 146. The gas duct 140 includes surface 148 that may be flared at the end mating with outlet housing section 138 to provide clearance for the vanes 150, and includes a profile 143 to provide the desired low pressure EGR inflow geometry. A variation may include forming the outlet housing section 138 and gas duct 140 as one piece so that the EGR gas port 142 may be provided in the outlet housing section. When the vanes 150 are closed, flow from the inlet port 152 is blocked and the source of fluid for a compressor that may be downstream from outlet port 154 is via flow in through the EGR gas port 142. In this manner a method is provided wherein low pressure EGR flow is maximized by closing the vanes 150.

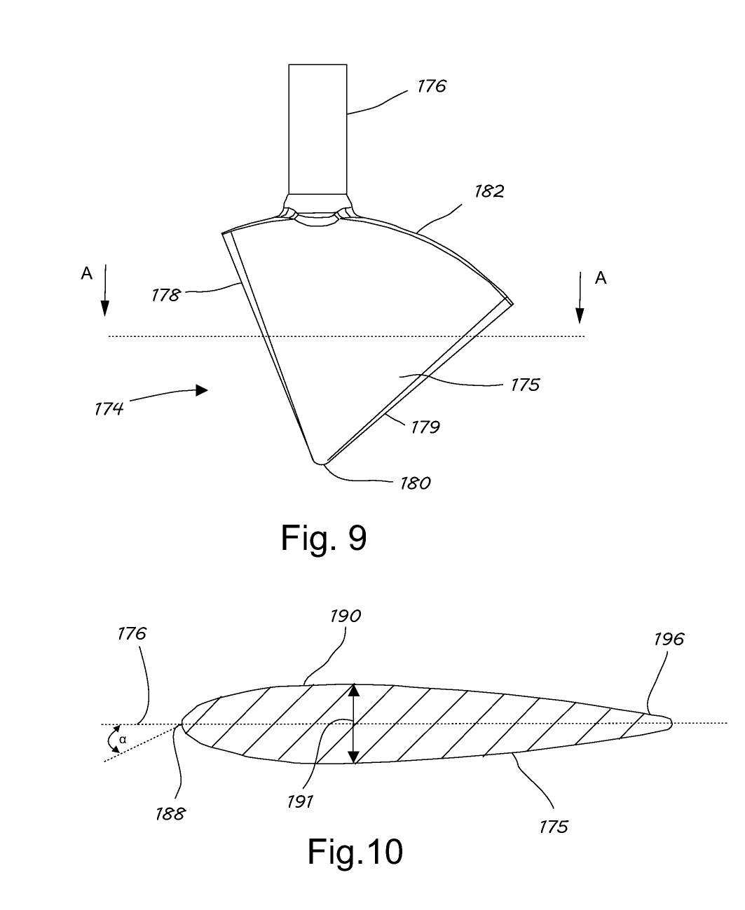

FIG. 8 shows a swirl type LP-EGR throttle mechanism 156 with an inlet passage 158 provided by inlet housing section 164 and actuation ring 166. Inlet passage 158 has an effective diameter D1. A vane chamber 160 may be provided by actuation ring 166 and outlet housing section 168. Vane chamber 168 has an effective diameter D2. An outlet passage 162 may be provided by outlet housing section 168 and have an effective diameter D3. The effective diameter may be the actual diameter in the case of a circular cross section or may be the hydraulic diameter for non-circular cross sections. Vane chamber 160 is shaped to closely match the radially outer profile of the vanes (shown in FIG. 9), and may be spherical, ellipsoidal or may be intersections of ellipsoidal and spherical shapes. The inlet passage 158 transitions to chamber 160 through an arcing expanding wall section 170, and the chamber 160 transitions to the outlet passage 162 through and arcing contracting wall section 172. For optimized vane actuator torque, swirl performance and minimized total pressure losses the ratio D2/D1 may range between 1.01 to 1.4, and the ratio D2/D3 may range between 1.25 to 1.5. As illustrated, the inlet housing section 164 and outlet housing section 168 may include hose type connections. A spherical shape as vane chamber 160, or a shape that deviates from a sphere in a range of plus or minus 15% of the base sphere diameter D2 may be used. The spherical like shape may be defined by a base sphere diameter such as D2 that represents a perfect sphere relative to which the internal surface of the vane chamber is defined.

FIG. 9 illustrates a single vane 174 having a vane element 175 and extending shaft 176. The vane element 175 may include straight edges 178 and 179 for mating with adjacent vanes, the angle of which is determined by the number of vanes used in an application. Edges 178 and 179 converge toward the center of the flow path and terminate at a flat point 180 to avoid binding. When the vane is positioned so as to minimize its effect on flow in a position parallel (0 degrees) to the axis of the flow path, side 178 is the leading edge and upstream side and side 179 is the trailing edge and downstream side. The outer circumference 182 of vane element 175 is shaped to fit closely within the chamber it operates (such as vane chamber 160 of FIG. 8) for minimal air gaps. The contour or outer circumference may be a radius X or an arc Y that appropriately fits the valve chamber's effective diameter and shape and considers manufacturability and aerodynamics. The contour or outer circumference of another variant may be a combination of radii or arcs that appropriately fits the valve chamber's effective diameter and shape to minimize gaps.

The performance of the swirl type LP-EGR throttle mechanism can be measured by the quality of the swirl flow profile at the outlet, and the pressure losses generated. For small closing angles, the performance characteristics of the vane elements may preferably be such that the swirl angles match the vane angles with minimized pressure losses.

While changing the direction of flow between the leading edge of the vanes and the outlet during rotation of the vanes, a natural pressure gradient may be created between the vanes. This may result in sub-flow running through the gap between vane contour and inner housing contour, from the pressure side of one vane to the suction side of the other vane. Minimized gap flow may be achieved through an approximately spherical housing contour and a vane contour which follows the housing contour. This results in a gap that has a consistent width, independent from the angle orientation of the vanes. The vane contour may be created by rotating a radius around the center axis, leading to an equal gap width around the vane.

FIG. 10 shows a cross section of the vane element 175 having a vane centerline 186. The aerodynamic shape, may exhibit each side similar to the top of an airfoil which may be an airfoil in which the camber and chord lines coincide, or one that simply has no camber. Such an airfoil may have a National Advisory Committee for Aeronautics designation NACA-00XX. This aerodynamic shape may minimize pressure losses at small angles α, between the flow direction 184 and the straight vane centerline 186. The cross section may have a nose circle forming a rounded leading edge 188 transitioning to an increased thickness section 190 with maximum thickness 191 which may be in the forward third of the vanes length. The cross section then tapers to a thin trailing end 192. Both sides (the top and bottom as oriented in FIG. 10), may be symmetrically shaped so that the vane can be rotated in either direction to induce swirl.

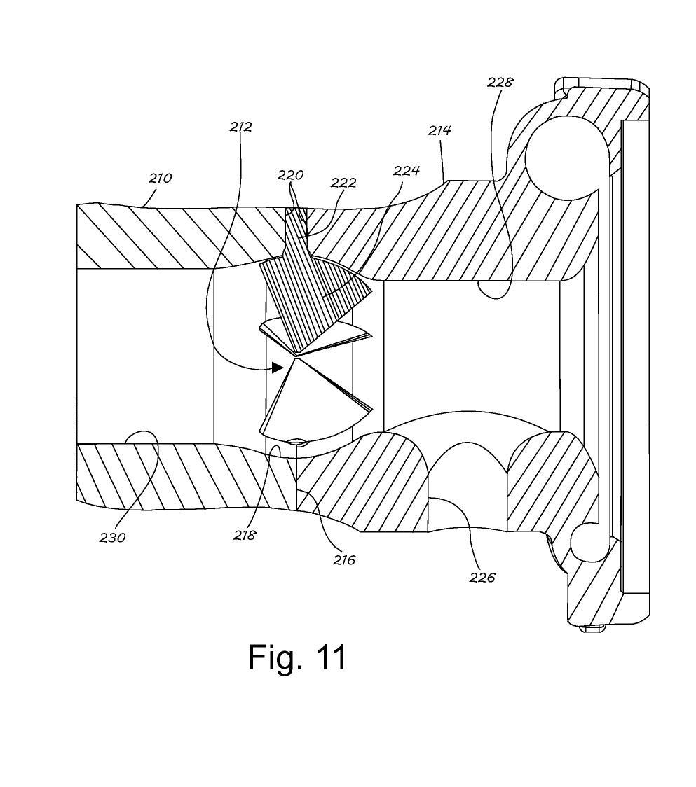

A valve housing 210 for a swirl type low pressure-EGR throttle mechanism 212 may be formed integrally with a compressor housing 214, or may be connected directly to a compressor housing 214 as shown in FIG. 11. The compressor housing 214 is configured to house a compressor for charging the intake system of an internal combustion engine. The parting line 216 between the valve housing 210 and the compressor housing 214 may be located at the centerline of the valve chamber 218 or may be located at another suitable location. The bearings 220 for the vanes of the swirl type low pressure-EGR throttle mechanism 212 may be formed by the valve housing 210 and the compressor housing 214, such as the opening formed by the housing sections within which shaft 222 of vane 224 is journaled. A low pressure-EGR inlet port 226 may be integrated into the compressor housing 214 and may open to the intake channel 228 downstream from the swirl type low pressure-EGR throttle mechanism 212. When the vanes of the throttle mechanism 212 are closed, flow from the inlet port 230 is blocked and the source of fluid for the compressor is flow in through the EGR inlet port 226. In this manner a structure is provided wherein low pressure EGR flow is maximized by closing the vanes of the throttle mechanism 212.

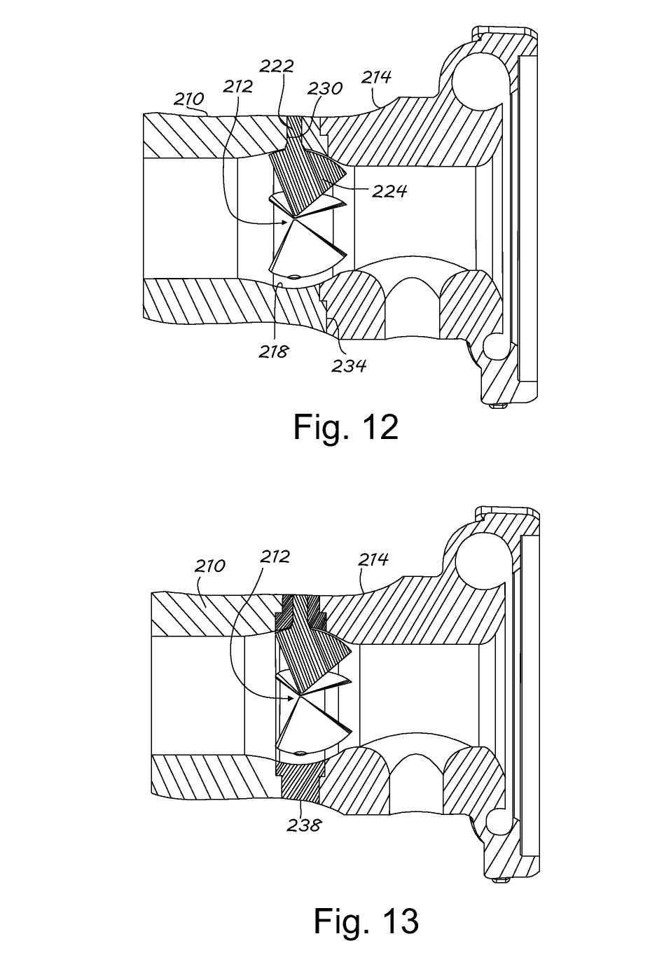

Referring to FIG. 12, individual bearing such as bearing 230 may be used in the directly attached valve housing 210 and compressor housing 214. The individual bearings 230 rotatably support the shafts such as shaft 222 of vane 224 and may be formed in the throttle valve side housing 210 as illustrated, or in the compressor housing 214. This moves the parting line 234 away from the centerline of the valve chamber 218. As shown in FIG. 13 a bearing ring 238 may be used in place of individual bearings for supporting the vanes of the throttle mechanism 212 as described in relation to FIGS. 4 through 6. The bearing ring 238 may be carried between the valve housing 210 and the compressor housing 214. The valve chamber 218 may be formed by the valve housing 210, bearing ring 238 and compressor housing 214.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include product including a housing with an exhaust gas port, an inlet passage, and an outlet passage joined to the inlet passage by a valve chamber containing a plurality of vanes. The vanes may be arranged to: substantially close flow through the valve chamber; and induce swirl between the inlet passage and the outlet passage in both a first direction and a second direction. When the vanes substantially close flow through the valve chamber, flow from the exhaust gas port to the outlet port may be induced.

Variation 2 may include a product according to variation 1 wherein at least part of the valve chamber may be defined by an actuation ring that may be rotatable to effect rotation of the vanes.

Variation 3 may include a product according to variation 1 or 2 wherein only one of the plurality of vanes may include a shaft that extends out of the housing and that may be configured to be rotatably driven.

Variation 4 may include a product according to variation 1 wherein the plurality of vanes includes a first vane and a set of other vanes. The first vane may include a shaft that extends out of the housing and that may be configured to be rotatably driven. An actuation ring may be configured to rotate in response to rotation of the first vane causing the set of other vanes to rotate in unison with the first vane

Variation 5 may include a product according to any of variations 1-4 wherein the plurality of vanes may be located in an upstream position relative to an exhaust gas recirculation port.

Variation 6 may include a product according to any of variations 1 through 5 wherein each of the plurality of vanes includes a vane element that has an airfoil like cross section.

Variation 7 may include a product according to any of variations 1 through 6 wherein the vanes substantially close flow between the inlet passage and the outlet passage without overlapping

Variation 8 may include a product according to any of variations 1 through 7 wherein each vane includes a shaft and a lever arm extending from the shaft

Variation 9 may include a product according to variation 8 wherein the actuation ring includes first and second radially extending arms coinciding with each lever arm.

Variation 10 may include a product according to variation 9 wherein each lever arm includes a ball joint positioned between the first and second radially extending arms.

Variation 11 may include a product according to any of variations 1-10 wherein the inlet passage may have a first effective diameter D1, the valve chamber may have a second effective diameter D2, and the outlet passage may have a third effective diameter D3. The ratio D2/D1 may preferably be between 1.01 and 1.04.

Variation 12 may include a product according to variation 11 wherein the ratio D2/D3 may preferably be between 1.25 and 1.5.

Variation 13 may include a mechanism for influencing flow. The mechanism may include an inlet port, an outlet port, and a flow passage between the inlet port and the outlet port. A valve chamber may be positioned in the flow passage. An exhaust gas port may be configured to admit a flow of exhaust gas into the flow passage and may open to the flow passage between the valve chamber and the outlet port. A set of vanes may be included wherein the set of vanes may be arranged to: induce swirl between the inlet port and the outlet port in both a first direction and a second direction; and close off flow from the inlet port thereby inducing flow from the exhaust gas port to the outlet port.

Variation 14 may include a mechanism according to variation 13 wherein the set of vanes may be positioned in a valve chamber. At least part of the valve chamber may be defined by an actuation ring that may be rotatable and configured to effect rotation of the vanes.

Variation 15 may include a mechanism according to variation 13 wherein each vane in the set of vanes may include a lever arm. An actuation ring may include a first and second radially extending arm corresponding to each lever arm. Each lever arm may extend between its corresponding first and second radially extending arms.

Variation 16 may include a mechanism according to variation 13 or 15 and may include a bearing that is annular shaped, is positioned around the set of vanes, and includes a set of openings. Each vane in the set of vanes may include an arm that extends through a corresponding opening in the bearing

Variation 17 may include a mechanism according to claim 16 wherein a slot may correspond to each vane in the set of vanes and may intersect each opening in the set of openings. Each vane in the set of vanes may include a lever arm extending through its corresponding slot.

Variation 18 may include a method according to variation 15 wherein the actuation ring may include a pair of arms that extend from the actuation ring and that may be configured to effect rotation of the vanes.

Variation 19 may include a method according to variation 18 wherein each vane in the set of vanes may include a lever arm that extends between one of the pairs of arms.

Variation 20 may include a mechanism for effecting swirl and for throttling flow. The mechanism may include an inlet port, an outlet port, and a flow passage between the inlet port and the outlet port. A valve chamber may be positioned in the flow passage. An exhaust gas port may be configured to admit a flow of exhaust gas into the flow passage. The exhaust gas port may open to the flow passage between the valve chamber and the outlet port. A set of vanes may be positioned in the valve chamber. Each vane in the set of vanes may include a leading edge, a trailing edge, and a maximum thickness that is located closer to the leading edge than to the trailing edge. The set of vanes may be configured to rotate to effect swirl and throttle flow. The set of vanes may also be configured to rotate closing off flow from the inlet port enhancing flow from the exhaust gas port to the outlet port.

Variation 21 may include a mechanism according to variation 13 wherein each vane may include a vane element, an extending shaft, a lever arm on the shaft, and a bearing joint on the shaft. The vane element, shaft, lever arm and bearing joint may be formed together by injection molding.

Variation 22 may include a mechanism according to variation 21 wherein the vane element, shaft, lever arm and bearing joint are formed as one piece comprised of at least two different materials.

Variation 23 may include a mechanism according to variation 21 wherein each shaft is formed in place in a bearing opening in the mechanism.

Variation 24 may include a mechanism according to variation 21 wherein each vane is molded on a respective shaft when the respective shaft is molded.

Variation 25 may include a mechanism according to variation 21 wherein each lever is molded on a respective shaft when the respective shaft is molded.

Variation 26 may include a mechanism according to variation 21 wherein a bearing is molded on each lever when the respective lever is molded.

Variation 27 may include a mechanism according to variation 13 wherein the valve chamber is spherical like in shape and includes an internal surface with a base sphere defined by the internal surface, the base sphere having a diameter, wherein the internal surface deviates from the diameter no more than plus or minus 15 percent.

Variation 28 may include a mechanism according to variation 13 wherein the mechanism is contained in a housing comprising no more than two separable sections.

Variation 29 may include a mechanism according to variation 28 wherein the exhaust gas port is defined by the two separable sections.

Variation 30 may include a mechanism according to variation 13 wherein the inlet port and at least part of the valve chamber may be formed in a first housing. The first housing may be connected directly to a second housing, and the second housing may be configured to house a compressor.

Variation 31 may include a mechanism according to variation 30 wherein the valve chamber is defined by the first housing and the second housing.

Variation 32 may include a mechanism according to variation 30 wherein the exhaust gas port is formed in the second housing.

Variation 33 may include a mechanism according to variation 30 with a bearing ring supporting the set of vanes and wherein the valve chamber may be defined by the first housing, the bearing ring, and the second housing

Variation 34 may include a mechanism according to variation 30 wherein the set of vanes is supported by the first housing.

The above description of select variations within the scope of the invention is merely illustrative in nature and, thus, variations or variants thereof are not to be regarded as a departure from the spirit and scope of the invention.

What is claimed is:

1. A product comprising a housing including an exhaust gas port, an inlet passage, and an outlet passage joined to the inlet passage by a valve chamber containing a plurality of vanes arranged to: substantially close flow through the valve chamber; and induce swirl between the inlet passage and the outlet passage in both a first direction and a second direction; wherein when the vanes substantially close flow through the valve chamber, flow from the exhaust gas port to the outlet port is induced.

2. A product according to claim 1 wherein at least part of the valve chamber is defined by an actuation ring that is rotatable to effect rotation of the vanes.

3. A product according to claim 1 wherein only one of the plurality of vanes includes a shaft that extends out of the housing and that is configured to be rotatably driven.

4. A product according to claim 1 wherein the plurality of vanes includes a first vane and a set of other vanes and wherein the first vane includes a shaft that extends out of the housing and that is configured to be rotatably driven and wherein an actuation ring is configured to rotate in response to rotation of the first vane causing the set of other vanes to rotate in unison with the first vane.

5. A product according to claim 1 wherein the plurality of vanes are located in an upstream position relative to the exhaust gas recirculation port.

6. A product according to claim 1 wherein each of the plurality of vanes includes a vane element that has an airfoil like cross section.

7. A product according to claim 1 wherein the vanes substantially close flow between the inlet passage and the outlet passage without overlapping.

8. A product according to claim 4 wherein each vane in the set of other vanes includes a shaft and a lever arm extending from the shaft.

9. A product according to claim 8 wherein the actuation ring includes first and second radially extending arms coinciding with each lever arm.

10. A product according to claim 9 wherein each lever arm includes a ball joint positioned between the first and second radially extending arms.

11. A product according to claim 1 wherein the inlet passage has a first effective diameter D1, the valve chamber has a second effective diameter D2, and the outlet passage has a third effective diameter D3, and wherein a ratio D2/D1 is preferably between 1.01 and 1.04.

12. A product according to claim 11 wherein a ratio D2/D3 is preferably between 1.25 and 1.5.

13. A mechanism for influencing flow comprising an inlet port, an outlet port, a flow passage between the inlet port and the outlet port, a valve chamber in the flow passage, an exhaust gas port configured to admit a flow of exhaust gas and opening to the flow passage between the valve chamber and the outlet port, and a set of vanes wherein the set of vanes are arranged to: induce swirl between the inlet port and the outlet port in both a first direction and a second direction; and close off flow from the inlet port thereby inducing flow from the exhaust gas port to the outlet port.

14. A mechanism according to claim 13 wherein the set of vanes are positioned in a valve chamber and wherein at least part of the valve chamber is defined by an actuation ring that is rotatable and configured to effect rotation of the vanes.

15. A mechanism according to claim 13 wherein each vane in the set of vanes includes a lever arm and an actuation ring includes a first and second radially extending arm corresponding to each lever arm and each lever arm extends between its corresponding first and second radially extending arms.

16. A mechanism according to claim 13 further comprising a bearing that is annular shaped, is positioned around the set of vanes, and includes a set of openings, wherein each vane in the set of vanes includes an arm that extends through a corresponding opening in the bearing.

17. A mechanism according to claim 16 wherein a slot corresponds to each vane in the set of vanes and intersects each opening in the set of openings and wherein each vane in the set of vanes includes a lever arm extending through its corresponding slot.

18. A mechanism according to claim 15 wherein the actuation ring includes a pair of arms that extend from the actuation ring and that are configured to effect rotation of the vanes.

19. A mechanism according to claim 18 wherein each vane in the set of vanes includes a lever arm that extends between one of the pairs of arms.

20. A mechanism for effecting swirl and for throttling flow comprising an inlet port, an outlet port, a flow passage between the inlet port and the outlet port, a valve chamber in the flow passage, an exhaust gas port configured to admit a flow of exhaust gas into the flow passage and opening to the flow passage between the valve chamber and the outlet port, and a set of vanes positioned in the valve chamber wherein each vane in the set of vanes includes a leading edge, a trailing edge, and a maximum thickness that is located closer to the leading edge than to the trailing edge and wherein the set of vanes is configured to rotate to effect swirl and throttle flow and is configured to rotate closing off flow from the inlet port enhancing flow from the exhaust gas port to the outlet port.

21. A mechanism according to claim 13 wherein each vane includes a vane element, an extending shaft, a lever arm on the shaft, and a bearing joint on the shaft, wherein the vane element, shaft, lever arm and bearing joint are formed together by injection molding.

22. A mechanism according to claim 21 wherein the vane element, shaft, lever arm and bearing joint are formed as one piece comprised of at least two different materials.

23. A mechanism according to claim 21 wherein each shaft is formed in place within a bearing opening in the mechanism.

24. A mechanism according to claim 21 wherein each vane element is molded on a respective shaft when the respective shaft is molded.

25. A mechanism according to claim 21 wherein each lever is molded on a respective shaft when the respective shaft is molded.

26. A mechanism according to claim 25 wherein a bearing is molded on each lever when the respective lever is molded.

27. A mechanism according to claim 13 wherein the valve chamber is spherical like in shape and includes an internal surface with a base sphere defined by the internal surface, the base sphere having a diameter, wherein the internal surface deviates from the diameter no more than plus or minus 15 percent.

28. A mechanism according to claim 13 wherein the mechanism is contained in a housing comprising no more than two separable sections.

29. A mechanism according to claim 24 wherein the exhaust gas port is defined by the two separable sections.

30. A mechanism according to claim 13 wherein the inlet port and at least part of the valve chamber are formed in a first housing and the first housing is connected directly to a second housing, wherein the second housing is configured to house a compressor.

31. A mechanism according to claim 30 wherein the valve chamber is defined by the first housing and the second housing.

32. A mechanism according to claim 30 wherein the exhaust gas port is formed in the second housing.

33. A mechanism according to claim 30 further comprising a bearing ring supporting the set of vanes and wherein the valve chamber is defined by the first housing, the bearing ring, and the second housing.

34. A mechanism according to claim 30 wherein the set of vanes is supported by the first housing.
